(19) United States
(12) Patent Application Publication
(10) Pub. No.: US 2010/0332763 A1
(43) Pub. Date: Dec. 30, 2010

(54) APPARATUS, SYSTEM, AND METHOD FOR CACHE COHERENCY ELIMINATION

(75) Inventors: Marcus L. Kornegay, Research Triangle Park, NC (US); Ngan N. Pham, Research Triangle Park, NC (US)

Correspondence Address: Kunzler Needham Massey & Thorpe, 8 EAST BROADWAY, SUITE 600, SALT LAKE CITY, UT, 84111, US

(73) Assignee: International Business Machines Corporation, Armonk, NY (US)

(21) Appl. No.: 12/495,176

(22) Filed: Jun. 30, 2009

(51) Int. Cl. G06F 12/08; G06F 12/00

(52) U.S. Cl. 711/130; 711/141; 711/207; 711/E12.001; 711/E12.061; 711/E12.026; 711/E12.038

(57) ABSTRACT

An apparatus, system, and method are disclosed for improving cache coherency processing. The method includes determining that a first processor in a multiprocessor system receives a cache miss. The method also includes determining whether an application associated with the cache miss is running on a single processor core and/or whether the application is running on two or more processor cores that share a cache. A cache coherency algorithm is executed in response to determining that the application associated with the cache miss is running on two or more processor cores that do not share a cache, and is skipped in response to determining that the application associated with the cache miss is running on one of a single processor core and two or more processor cores that share a cache.

### BACKGROUND

1. Field of the Invention

This invention relates to cache coherency between processor caches and more particularly relates to eliminating cache coherency processing in some cases for multiprocessor systems.

2. Description of the Related Art

A computer system is typically made up of at least one processor that executes instructions and at least one main memory where the instructions are stored. The main memory is typically a faster, volatile memory such as random access memory (“RAM”) or read only memory (“ROM”). However, in some cases the main memory may include non-volatile memory such as flash memory, a hard-disk drive, etc. Modern processors use a processor cache to more efficiently transfer instructions between the main memory and the processor. Typically a processor cache is smaller, faster memory which stores copies of the data from the most frequently used memory locations. As long as most memory accesses are cached memory locations, the average latency of memory accesses will be closer to the cache latency than to the latency of main memory.

When a processor needs to read from or write to a main memory location, the processor first checks whether a copy of that data is in the cache. If the data is found in the cache, then the processor immediately reads from or writes to the cache, which is much faster than reading from or writing to main memory. If data is requested but not found in the cache, that is referred to as a “cache miss.” Typically, a cache miss requires an access of the main memory to retrieve the desired data. In some cases, a cache miss may even require an access to a non-volatile storage device beyond the main memory such as a hard-disk drive access. Thus, caches misses can significantly slow down system processes.

Multi-processor systems or systems with more than one processor present even more difficulties with regard to cache misses. In multi-processor systems, cache coherency protocol is necessary to protect data integrity stored in processor caches and memory. Typically, each processor in a multi-processor system has its own cache that services one or more cores on the processor. Some processors have multi-level caches such that a first level cache is accessed before a second level cache which is accessed before a third level cache, etc. One level is accessed last is a last level cache (“LLC”).

An LLC is typically the last cache that may contain the requested data before an access of main memory is required. Although LLCs are sometimes shared between different processor cores on the same processor socket, caches, including LLCs are not typically shared between processors in different sockets. Therefore, in conventional systems, every time a processor has a cache miss in its last level cache, a cache coherency algorithm is executed before the requested cache line is brought in from main memory for processor use. A cache coherency algorithm ensures coherency between the unshared caches of different processors in a multi-processor system.

The problem with the conventional art is that while cache coherency is important and continuously being worked on to improve its efficiency, there are times where the cache coherency algorithm is not necessary. If a cache coherency algorithm is executed when execution is unnecessary (e.g. when an application is running that does not use multiple unshared processor caches), system performance is negatively impacted, because the cache coherency algorithm slows down system execution and injects unnecessary traffic on system buses.

### BRIEF SUMMARY

From the foregoing discussion, it should be apparent that a need exists for an apparatus, system, and method that improves cache coherency processing in multi-processor systems. Beneficially, such an apparatus, system, and method would identify situations where a cache coherency algorithm does not need to be executed after a cache miss, and would skip execution of the cache coherency algorithm is those situations. For example, a single threaded application will typically run on a single processor core. Therefore, it usually cannot be run across multiple processors with unshared caches, and a cache miss associated with such an application will not require execution of a cache coherency algorithm. Further, a multi-threaded application that is running only on plurality of processor cores that share a cache does not require execution of a cache coherency algorithm in the event of a cache miss. This becomes more common as the number of cores per processor socket increases over time.

The present invention has been developed in response to the present state of the art, and in particular, in response to the problems and needs in the art that have not yet been fully solved by currently available cache coherency devices. Accordingly, the present invention has been developed to provide an apparatus, a system, and a method for improving cache coherency processing that overcome many or all of the above-discussed shortcomings in the art.

The apparatus to improve cache coherency processing is provided with a plurality of modules configured to functionally execute the necessary steps for determining whether a cache coherency algorithm is necessary after a cache miss and either executing or skipping the cache coherency algorithm accordingly. These modules in the described embodiments include a cache miss module, a determination module, and a cache coherency module.

The cache miss module determines that a first processor in a multiprocessor system receives a cache miss. The cache miss occurs in response to a request for data from a cache associated with the first processor. The multiprocessor system includes two or more processors, wherein each processor in the multiprocessor system includes one or more processor cores.

The determination module determines one or more of whether an application associated with the cache miss is running on a single processor core and whether an application that is running on two or more processor cores is running on two or more processor cores that do not share a cache.

The cache coherency module executes a cache coherency algorithm in response to the determination module determining that the application associated with the cache miss is running on two or more processor cores that do not share a cache. The cache coherency algorithm checks for consistency between two or more unshared caches. The cache coherency module skips execution of the cache coherency algorithm in response to the determination module determining that the application associated with the cache miss is running on one of a single processor core and two or more processor cores that share a cache.

In one embodiment, the determination module identifies a memory region assigned to an application that is running on one of a single processor core and two or more processor cores that share a cache and flags the memory region assigned to the application to indicate that the application is running on one of a single processor core and two or more processor cores that share a cache. In a further embodiment, the determination module determines that the application associated with the cache miss is running on one of a single processor core and two or more processor cores that share a cache by determining that the memory region assigned to the application is flagged. In yet a further embodiment, the memory region associated with the application is flagged in a translation lookaside buffer associated with the first processor. The memory region associated with the application may be flagged in the translation lookaside buffer in response to the application being loaded into random access memory (“RAM”).

In one embodiment, the determination module determines that the application associated with the cache miss is running on one or more processor cores that share a cache by accessing a spare bit in a binary instruction set associated with the application. The spare bit indicates whether the application is running on one or more of a single processor and two or more processor cores that share a cache. The spare bit may be set during compilation of the application. For example, a spare bit of each binary instruction set associated with the application may be set during compilation of the application to indicate that the application is running on one or more of a single processor and two or more processor cores that share a cache

In one embodiment of the apparatus, the cache miss occurs in response to a request for data from a last level cache. The last level cache may be shared between two or more processor cores of the first processor. In a further embodiment, the first processor is associated with a multi-level cache. The multi-level cache typically includes the last level cache and one or more additional caches including at least a first level cache. The first level cache is the first cache from which data is requested by the first processor. The last level cache is the last cache from which data is requested by the first processor before a memory access is necessary. In a further embodiment, the apparatus may be configured such that two or more processors of the multiprocessor system share a cache.

A system of the present invention is also presented to improve cache coherency processing in multi-processor systems. The system may be embodied to substantially include the steps and embodiments described above with regard to the apparatus. In particular, the system, in one embodiment, includes a cache miss module, a determination module, and a cache coherency module as described above. The system may also include a multiprocessor digital processing device that includes two or more processors and at least one cache associated with the two or more processors. Each processor includes one or more processor cores.

In various embodiments, the digital processing device may be a personal computer, laptop, server, personal digital assistant, a cell phone, or other device that may utilizes multiple processors.

In one embodiment, the system includes a memory where the determination module identifies a memory region within the memory assigned to an application that is running on one of a single processor core and two or more processor cores that share a cache. The determination module flags the identified memory region. In a further embodiment, the determination module determines that the application associated with the cache miss is running on one of a single processor core and two or more processor cores that share a cache by determining that the memory region assigned to the application is flagged.

In another embodiment of the system, the system may include a translation lookaside buffer associated with the first processor. The translation lookaside buffer may be configured to track memory addresses associated with the memory. The memory region associated with the application may be flagged by flagging addresses in the lookaside buffer associated with the identified memory region as being assigned to an application that is running on one of a single processor core and two or more processor cores that share a cache.

A method of the present invention is also presented for improving cache coherency processing in multi-processor systems. The method in the disclosed embodiments substantially includes the steps necessary to carry out the functions presented above with respect to the operation of the described apparatus and system. In one embodiment, the method includes determining that a first processor in a multiprocessor system receives a cache miss, wherein the cache miss occurs in response to a request for data from a cache associated with the first processor. The multiprocessor system typically includes two or more processors, wherein each processor in the multiprocessor system includes one or more processor cores.

The method also may include determining whether an application associated with the cache miss is running on a single processor core or whether an application that is running on two or more processor cores is running on two or more processor cores that do not share a cache.

In a further embodiment, the method includes executing a cache coherency algorithm in response to determining that the application associated with the cache miss is running on two or more processor cores that do not share a cache. The cache coherency algorithm checks for consistency between two or more unshared caches. In yet a further embodiment of the method, execution of the cache coherency algorithm is skipped in response to determining that the application associated with the cache miss is running on one of a single processor core and two or more processor cores that share a cache.

In one embodiment, the method includes identifying a memory region assigned to an application that is running on a single processor core or two or more processor cores that share a cache and includes flagging the memory region assigned to the application. In a further embodiment, the method includes determining one or more of whether the application associated with the cache miss is running on one of a single processor core and two or more processor cores that share a cache by determining that the memory region assigned to the application is flagged.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for improving cache coherency processing in accordance with the present invention;

FIG. 2 is a schematic block diagram illustrating a further embodiment of a system for improving cache coherency processing in accordance with the present invention;

FIG. 3 is a schematic block diagram illustrating one embodiment of a cache coherency processing apparatus for improving cache coherency processing in accordance with the present invention;

FIG. 4 is a schematic block diagram illustrating a further embodiment of a system for improving cache coherency processing in accordance with the present invention;

FIG. 5 is a schematic flow chart diagram illustrating one embodiment of a method for improving cache coherency processing in accordance with the present invention; and

FIG. 6 is a schematic flow chart diagram illustrating another embodiment of a method for improving cache coherency processing in accordance with the present invention.

### DETAILED DESCRIPTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable media.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of storing machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

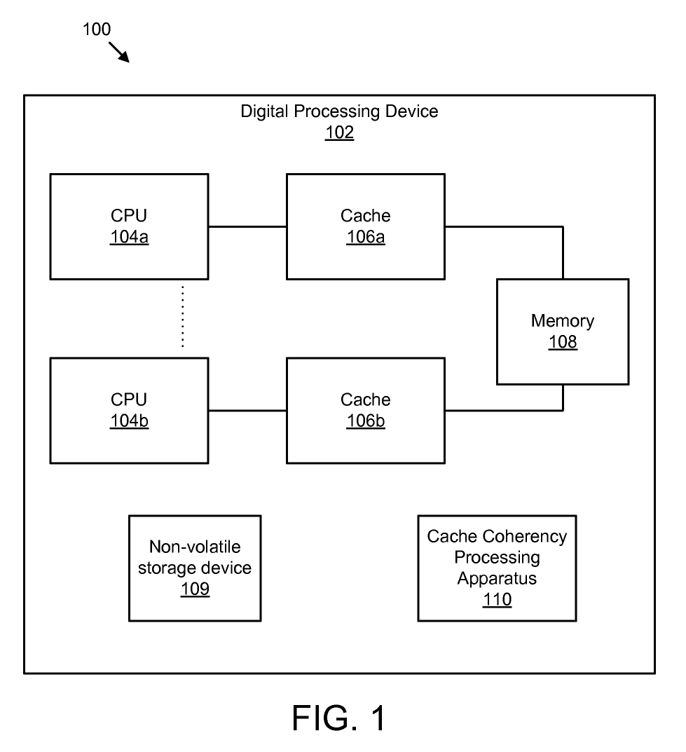

FIG. 1 is a schematic block diagram illustrating one embodiment of a system 100 for improving cache coherency processing in accordance with the present invention. The system 100 includes a digital processing device 102 with two or more processors 104a-b, a cache 106a-b associated with each processor 104a-b, a memory 108, a non-volatile storage device 109, and a cache coherency processing apparatus 110.

In various embodiments, the digital processing device 102 may be any type of electronic device that is configured to implement two or more processors 104a-b or central processing units (“CPUs”) for executing computer programs and applications. Examples include a personal computer, laptop, server, personal digital assistant, cell phone, etc. and other devices as recognized by those of skill in the art. The digital processing device 102 may also include numerous additional parts and devices such as non-volatile or long-term storage devices 109 (e.g. hard disk drives, tape drives), input/output devices, and display devices. Typically, each processor 104a-b is associated with a corresponding cache 106a-b. However, it is contemplated that two or more processors 104a-b may be configured to share a cache in some embodiments.

A processor cache 106a-b is a cache used by the processor 104a-b to reduce the average time to access data from the memory 108. The cache 106a-b typically includes smaller, faster memory that is used to store copies of data from the most frequently used main memory 108 locations. Some processors utilize more than one type of cache such as an instruction cache to speed up fetches of executable instructions, a data cache to speed up data fetches and stores, and a translation lookaside buffer to speed up virtual-to-physical address translations for both data and instruction fetches.

In operation, when the processor 104a-b needs data from the memory 108, it first checks the cache 106a-b to determine if the data is already stored in the cache 106a-b. If the data is stored in the cache, it is called a “cache hit” and the processor 104a-b may proceed to read or write the data to or from the cache 106a-b. Reads and writes to the cache 106a-b are typically much faster than reads and writes to the main memory 108. Thus, processing efficiency is dramatically increased if the data is found in the cache 106a-b.

If the processor 104a-b requests data from the cache 106a-b and the data is not found in the cache 106a-b, it is called a “cache miss.” A cache miss requires that the requested data be accessed in the main memory 108. An access of the main memory 108 is significantly slower than accessing data in the cache 106a-b. In some cases, an access to a non-volatile storage device 109, such as a hard-disk drive, may be needed if the data is not found in the main memory 108. An access to a non-volatile storage device 109 is typically even slower than an access to the main memory 108. Changes that are made to the cache 106a-b must also eventually be made to the main memory 108. However, in the interest of improving efficiency, changes to the cache 106a-b may not be immediately reflected in the main memory 108. Instead, cache policies may be implemented to cause the changes to the cache 106a-b to be reflected in the main memory 108 at a particular time or in a particular way that increases the overall efficiency of the system 100.

In multi-processor systems 100, the caches 106a-b associated with each processors 104a-b are typically unshared meaning that each processor socket has its own corresponding cache 106a-b. Thus, the possibility arises where the same data from the main memory 108 is stored in two different caches 106a-b. Changes to the data in the caches 106a-b may not be immediately reflected in the main memory 108. Therefore, if a cache miss occurs for a first processor 104a, and it is forced to access data from the memory 108, then it becomes necessary to ensure that the data has not already been changed by a second processor 104b in a second cache 106b associated with the second processor 104b. Cache managers are typically utilized in conventional multi-processor systems to ensure that the data remains consistent between the caches 106a-b and the main memory 108. The algorithms and protocols used by the cache managers to maintain data consistency are referred to as cache coherency protocols or cache coherency algorithms. The cache coherency algorithms add additional processing time that reduces system efficiency.

As will be recognized by those of skill in the art, many cache coherence mechanisms are conventionally available. Examples of cache coherence mechanisms include directory-based coherence, snooping, and snarfing. In a directory-based mechanism, data is placed in a common directory that maintains coherence between two or more different caches 106a-b. The directory provides permission to a processor 104a-b to load data from the main memory 108 to a cache 106a-b. When the data is changed in the cache 106a-b, the directory may update or invalidate corresponding data in other caches 106a-b. In a snooping based mechanism, an individual cache 106a may monitor address lines for accesses to main memory locations from other caches 106b. If a data operation, such as a write, is observed from another cache 106a-b, the cache 106a-b invalidates its own copy of the snooped memory location. In a snarfing mechanism, an individual cache 106a watches both address and data in order to attempt to update its own copy of data in the event that the data is changed by a second cache 106b.

The main memory or memory 108 as used herein typically refers to random access memory (“RAM”) as will be recognized by those of skill in the art. The memory 108 is used to store program and application information including data and instructions. However, as will be recognized by those of skill in the art, digital processing devices 102 may utilize other types of memory for this purpose such as read only memory (“ROM”), flash memory, hard-disk drives, etc. In a typical embodiment, the main memory is RAM and instructions are moved into the RAM for exaction from a secondary non-volatile storage device 109 such as a hard-disk drive, flash memory, tape drive, or other type of non-volatile storage.

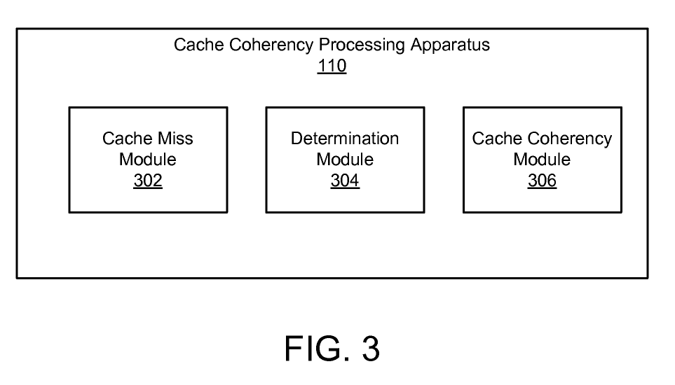

As depicted, the digital processing apparatus includes a cache coherency processing apparatus 110. The cache coherency processing apparatus 110 includes the logic necessary to improve cache coherency processing in the multi-processor system. As will be described in detail below with regard to FIG. 3, the cache coherency processing apparatus identifies situations where a cache coherency protocol would normally be executed in conventional systems, but where execution of the cache coherency algorithm is unnecessary. Then, the cache coherency processing apparatus 110 executes the cache coherency algorithm if necessary, and skips execution of the cache coherency algorithm if unnecessary. This enables improvement of the system 100 latency caused by unnecessary execution of the cache coherency algorithm and reduces bus bandwidth utilization to improve overall system 100 performance.

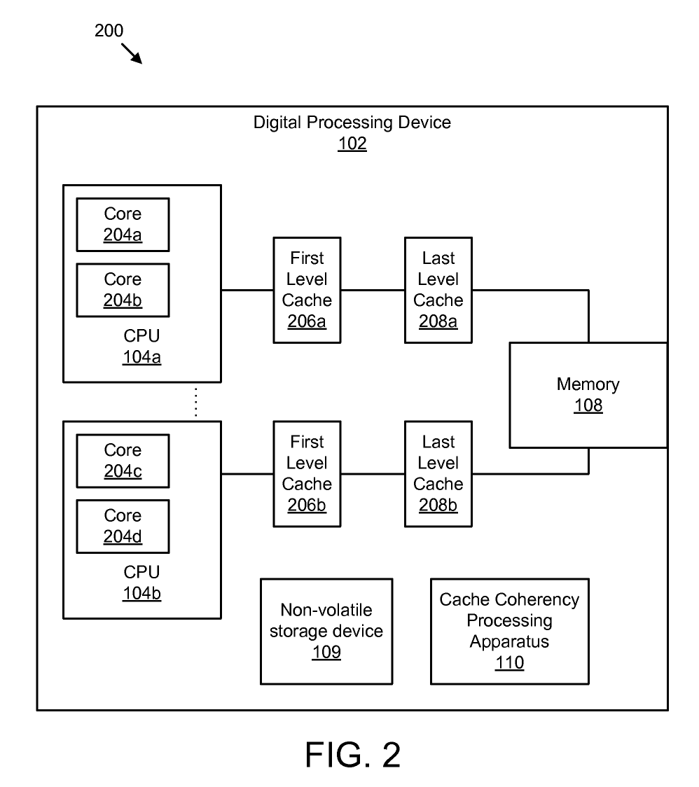

FIG. 2 is a schematic block diagram illustrating a further embodiment of a system 200 for improving cache coherency processing in accordance with the present invention. The system 200 includes the digital processing device 102, the processors 104a-b, and the cache coherency processing apparatus 110 as depicted in FIG. 1. However, the processors 104a-b are depicted with two or more processor cores 204a-d and with a multi-level cache corresponding to each processor 104a-b including a first level cache 206a-b and a last level cache 208a-b.

A multi-core processor 104a-b combines two or more processor cores 204a-b into a single package typically on a single integrated chip. Multi-core processors 204a-b are becoming increasingly common as demand for faster and more efficient processing increases. Each core in a multi-core processor can be used to independently implement improved functionality such as superscalar execution, pipelining, and multithreading.

For example, with regard to multithreading, an application may be single threaded or multi-threaded. A single threaded application typically runs on a single core 204a of a single processor 104a. However, a multi-threaded application may simultaneously run different threads on different cores 204a-b of the same processor 104a or on two or more cores 204a, 204c of two or more independent processors 104a-b. Multi-threaded applications are on example of an embodiment wherein a cache incoherency may result between two different caches 106a-b as a result of multiple threads utilizing data from the same memory 108 locations.

As depicted in FIG. 2, some processors 104a-b in accordance with the present invention may be associated with a multi-level cache that includes a first level cache 206a-b and a last level cache 208a-b. Those of skill in the art will recognize that additional cache levels may also be utilized. Because caches 106a-b that are very small have a high cache miss rate, andbecause caches 106a-b that are verylargehave a slowerprocessing time, some digital processing devices 102 may utilize multiple levels of cache 106a-b to improve efficiency. Typically, the first level cache 206a-b is smaller and faster than the last level cache 208a-b. Thus, if a cache hit occurs in the first level cache 206a-b, then processor can access the data very quickly without needed to access further cache levels or the main memory 108.

If a cache miss occurs in the first level cache 206a-b, the next larger cache, in this case the last level cache 208a-b is then checked for the missing data. Although, the last level cache 208a-b is typically slower than the first level cache 206a-b, it is usually larger and therefore more likely to contain the desired data. In some configurations, each processor core 204a-b may have its one independent first level cache 206a and may still share a last level cache 208a as will be recognized by those of skill in the art.

The cache coherency processing apparatus 1 10 is preferably configured to improve cache coherency processing in multi-processor systems including systems with multi-core processors and multi-level caches including various combinations with single core processors, multi-core processors, single level caches, and multi-level caches.

FIG. 3 is a schematic block diagram illustrating one embodiment of a cache coherency processing apparatus 110 for improving cache coherency processing in accordance with the present invention. The cache coherency processing apparatus 110 includes a cache miss module 302, a determination module 304, and a cache coherency module 306.

The cache miss module 302, in one embodiment, is configured to determine that a first processor 104a in a multiprocessor system 100, 200 receives a cache miss. The cache miss occurs in response to a request for data from a cache 106a associated with the first processor 106a, wherein the data is not available in the cache 106a. In some embodiments a cache miss may include a cache miss at each level of a multi-level cache 206a-b, 208a-b including a miss at a last level cache 208a-b. In other embodiments, a cache miss may include a miss at any single level of a multi-level cache 206a-b, 208a-b. By determining that a cache miss has been received by the first processor 104a, the cache miss module 302 identifies that execution of a cache coherency sequence may be needed as the data will have to be retrieved from another location such as the main memory 108.

In one embodiment, the cache miss module 302 may determine that a cache miss has occurred by monitoring or receiving such an indication from the first processor 104a, the cache 106a, both, or by communicating with a controller or management device associated with the first processor 104a or cache 106a. In other embodiments, the cache miss module 302 may determine that a cache miss has occurred in response to an attempt by the first processor 104a to access the main memory 108.

The determination module 304 determines one or more of whether an application associated with the cache miss runs on a single processor core 204a and whether an application that runs on two or more processor cores 204a-b runs on two or more processor cores 204a-b that do or do not share a cache 106a-b. These situations are reflective of the situations wherein a cache coherency algorithm may be skipped. For example, if an application runs only on a single processor core 204a, then only a single cache 106a will be utilized in accordance with that application. Therefore, cache incoherence between two independent caches 106a-b cannot occur, and execution of a cache coherency algorithm is not necessary. This typically occurs where an application is a single threaded application or where a multi-threaded application is designated to run on only a single processor core.

Further, if an application runs only on two or more processor cores that share a cache 106a-b, then again, a cache incoherency cannot occur because the same cache is being used for both processor cores. This is common when a multi-threaded application is configured to run on two or more processor cores 204a-b of the same processor 104a. Again, because a cache incoherency cannot occur, it is not necessary to execute a cache coherency algorithm to check the coherency between different caches 106a-b in the multi-processor system 100, 200.

In one embodiment, the determination module 304 may identify a memory region assigned to an application that is configured to run on either a single processor core 204a or on multiple processor cores 204a-b of the same processor 204a-b (in other words, an application that doesn't require cache coherency checks). Once the memory region assigned to the application is identified, the determination module 304 may flag that memory region accordingly. In one embodiment, this may occur as the application is loaded into RAM or memory 108 from a permanent storage device. Subsequently, the determination module 304 may determine that the application associated with a cache miss doesn't require execution of a cache coherency algorithm (runs on one of single processor core 204a or two or more processor cores 204a-b that share a cache 206a, 208a ) by determining that the memory region assigned to the application is flagged.

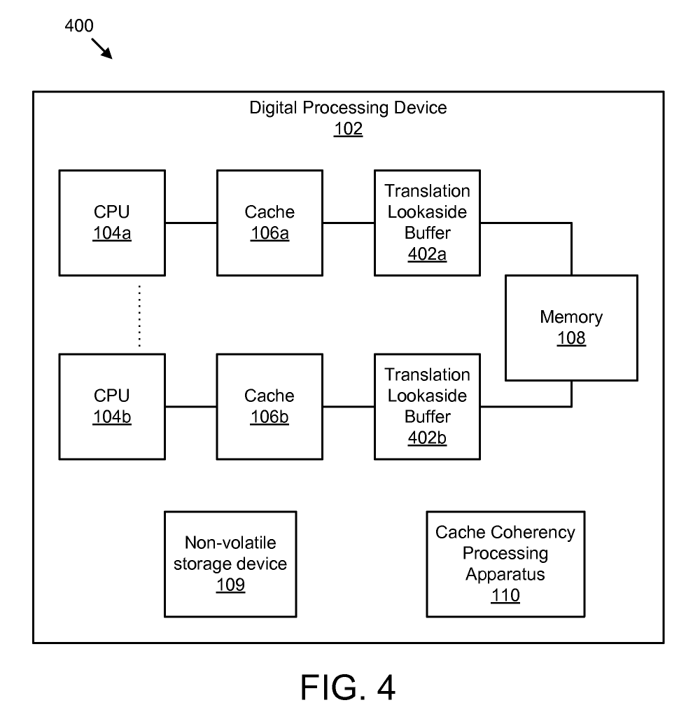

In one embodiment, a translation lookaside buffer 402a-b (see FIG. 4) may be used to flag the appropriate memory region. FIG. 4 is a schematic block diagram illustrating a further embodiment of a system 400 for improving cache coherency processing in accordance with the present invention that includes a translation lookaside buffer 402a-b associated with one or more processors 104a-b. A translation lookaside buffer 402a-b typically includes a table of entries that map virtual addresses onto physical addresses (e.g. physical addresses for accessing the main memory 108). The translation lookaside buffer 402a-b is typically a content-addressable memory in which a search key is the virtual address and the search result is a physical address of the main memory 108. If an address is found in the translation lookaside buffer 402a-b the address may be retrieved in a quick efficient manner. If an address is not found in the translation lookaside buffer 402a-b, then additional processing is required including, for example, accessing a page table which is slower to access.

As depicted in FIG. 4, the translation lookaside buffer 402a-b resides between the cache 106a-b and the memory 108. However in other embodiments it may reside between the processor 104a-b and the cache 106a-b or in some other location depending on the configuration of the system 400. This typically depends on whether the cache 106a-b uses virtual or physical addressing.

Thus in accordance with the present invention, a memory region in the memory 108 may be associated with a range of addresses in the translation lookaside buffer 402a-b, and the addresses in that range may be flagged by the determination module to indicate that those addresses are associated with an application wherein a cache miss doesn't require execution of a cache coherency algorithm (is running on one of single processor core 204a or two or more processor cores 204a-b that share a cache 206a, 208a ). Again, the flags in the translation lookaside buffer 402a-b may be set as the application is loaded into memory 108.

In another embodiment, the determination module 304 may determine that the application associated with the cache miss doesn't require execution of a cache coherency algorithm (is running on one of single processor core 204a or two or more processor cores 204a-b that share a cache 206a, 208a ), by accessing a spare bit in a binary instruction set associated with the application. For example, a spare bit of each instruction set associated with an application may be set to indicate that that application doesn't require execution of a cache coherency algorithm. Setting of the spare bit would typically occur during compilation of the application.

In yet another embodiment, the operating system may assign a particular application to run only on a single processor core 204a or on two or more processor cores 204a-b that share a cache 106a. In such an embodiment, the determination module 304 may receive notification from the operating system that a particular application has been assigned in such a manner. In response, the determination module 304 may accordingly flag the memory region associated with the application or the determination module 304 my use some alternate means to identify the application as not requiring execution of cache coherency algorithms in the event of a cache miss.

The cache coherency module 306 executes a cache coherency algorithm in response to the determination module 304 determining that the application associated with the cache miss is running on two or more processor cores 204a, 204c that do not share a cache 106a-b. In other words, if the determination module 304 determines that the associated application is an application that is running on two or more processor cores 204a, 204c (e.g. a multi-threaded application), and if the processor cores 204a, 204c that the application is running on do not share a cache 106a-b, then execution of the cache coherency algorithm is still required to maintain data integrity.

However, if the determination module 304 determines that the application associated with the cache miss is running on either a single processor core 204a or is running on two or more processor cores 204a-b with a shared cache 206a, 208a, then the cache coherency module 306 skips execution of the cache coherency algorithm. By skipping execution of the cache coherency algorithm is situation that it is unnecessary, the overall efficiency of the system 100, 200, 400 is increased.

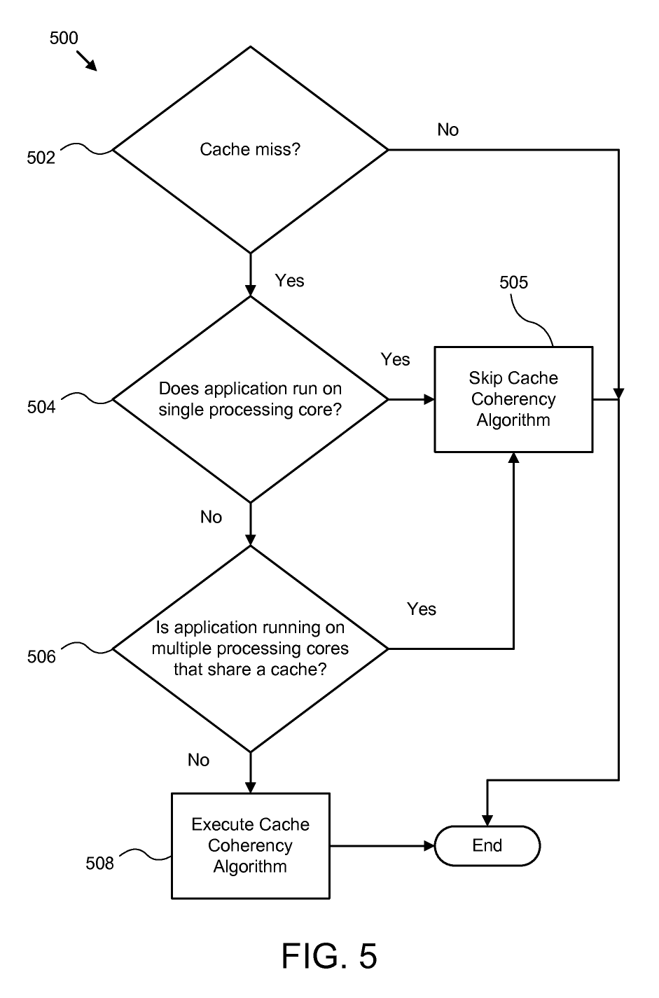

FIG. 5 is a schematic flow chart diagram illustrating one embodiment of a method 500 for improving cache coherency processing in accordance with the present invention. The method 500 substantially includes the steps and embodiments described above with regard to FIGS. 1-4.

The method 500 begins when a cache miss module 302 determines 502 whether a request for data from a cache 106a by a first processor 104a resulted in a cache miss. If a cache miss was not received by the first processor 104a and the cache miss module 302 determines 502 that a cache miss was not received the method 500 ends. If the cache miss module 302 determines 502 that a cache miss was received by the first processor, a determination module 304 determines 504 whether an application associated with the cache miss is running on a single processor core 204a (e.g. is single threaded or assigned to run on only a single processor core 204a ).

If the determination module 304 determines 504 that the application is running on only a single processor core 204a, then a cache coherency module 306 skips 505 execution of a cache coherency algorithm and the method 500 ends. The cache coherency algorithm checks for consistency between two or more unshared caches 106a-b in a multiprocessor system 100, 200, 400. If the determination module 304 determines 504 that the application is not running on only a single processor core 204a (e.g. is multi-threaded), then the determination module 304 determines 506 whether the application is running on multiple processing cores 204a-b that share a cache 206a, 208a.

If the determination module 304 determines 506 that the application is running on multiple processing cores 204a-b that share a cache 206a, 208a, then a cache coherency check is not needed, and the cache coherency module 306 skips 505 execution of a cache coherency algorithm and the method 500 ends. If the determination module 304 determines 506 that the application is running on multiple processor cores 204a, 204c that do not share a cache 206a, 208a, then the cache coherency module 306 executes 508 a cache coherency algorithm to ensure coherency between the caches 106a-b in the multiprocessor system 100, 200, 400 and the method 500 ends.

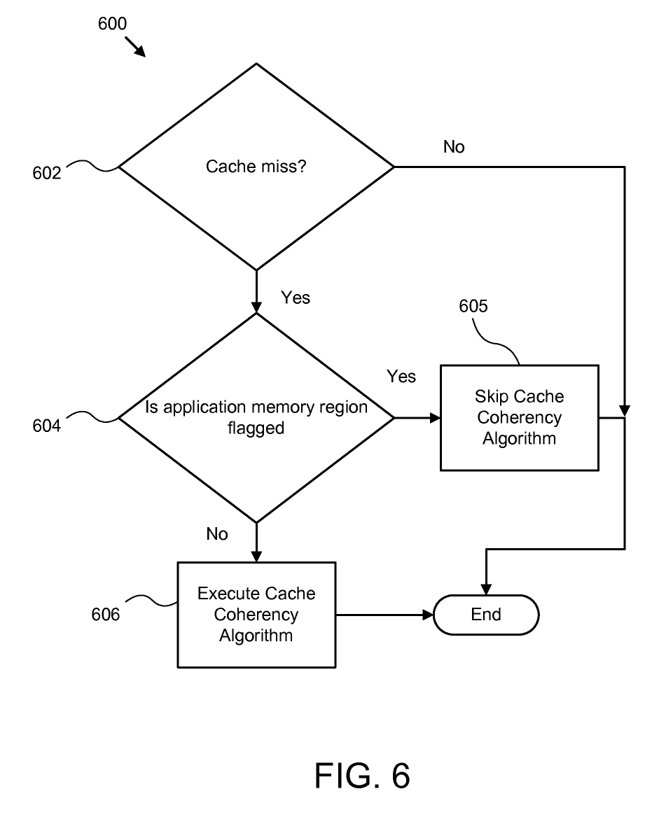

FIG. 6 is a schematic flow chart diagram illustrating another embodiment of a method 600 for improving cache coherency processing in accordance with the present invention. Again, the method 600 substantially includes the steps and embodiments described above with regard to FIGS. 1-5.

The method 600 begins when a cache miss module 302 determines 602 whether a request for data from a cache 106a by a first processor 104a resulted in a cache miss being received by the first processor 104a. If a cache miss was not received by the first processor 104a, then the method 600 ends. If the cache miss module 302 determines 602 that a cache miss was received by the first processor 104a, a determination module 304 determines 504 whether a memory region assigned to an application associated with the cache miss has been flagged as not requiring execution of a cache coherency algorithm in the event of a cache miss.

If the determination module 304 determines 604 that the memory region has been flagged, then a cache coherency module 306 skips 605 execution of a cache coherency algorithm and the method 600 ends. If the determination module 304 determines 604 that the memory region associated with the application has not been flagged, then the cache coherency module 306 executes 606 a cache coherency algorithm and the method 500 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to improve cache coherency processing in multi-processor systems,: the apparatus comprising:
a cache miss module that determines that a first processor in a multiprocessor system receives a cache miss, the cache miss occurring in response to a request for data from a cache associated with the first processor, the multiprocessor system comprising two or more processors, each processor in the multiprocessor system comprising one or more processor cores;
a determination module that determines one or more of whether an application associated with the cache miss is running on a single processor core and whether an application that is running on two or more processor cores is running on two or more processor cores that do not share a cache; and
a cache coherency module that executes a cache coherency algorithm in response to the determination module determining that the application associated with the cache miss is running on two or more processor cores that do not share a cache, the cache coherency algorithm checking for consistency between two or more unshared caches, wherein the cache coherency module skips execution of the cache coherency algorithm in response to the determination module determining that the application associated with the cache miss is running on one of a single processor core and two or more processor cores that share a cache.

2. The apparatus of claim 1, wherein the determination module identifies a memory region assigned to an application that is running on one of a single processor core and two or more processor cores that share a cache and flags the memory region assigned to the application to indicate that the application is running on one of a single processor core and two or more processor cores that share a cache.

3. The apparatus of claim 2, wherein the determination module determines that the application associated with the cache miss is running on one of a single processor core and two or more processor cores that share a cache by determining that the memory region assigned to the application is flagged.

4. The apparatus of claim 3, wherein the memory region associated with the application is flagged in a translation lookaside buffer associated with the first processor.

5. The apparatus of claim 4, wherein the memory region associated with the application is flagged in the translation lookaside buffer in response to the application being loaded into random access memory (“RAM”).

6. The apparatus of claim 1, wherein the determination module determines that the application associated with the cache miss is running on one or more processor cores that share a cache by accessing a spare bit in a binary instruction set associated with the application, the spare bit indicating that the application is running on one or more of a single processor and two or more processor cores that share a cache.

7. The apparatus of claim 6, wherein the spare bit is set during compilation of the application.

8. The apparatus of claim 7, wherein a spare bit of each binary instruction set associated with the application is set during compilation of the application to indicate that the application is running on one or more of a single processor and two or more processor cores that share a cache.

9. The apparatus of claim 1, wherein the cache miss occurs in response to a request for data from a last level cache.

10. The apparatus of claim 9, wherein the last level cache is shared between two or more processor cores of the first processor.

11. The apparatus of claim 9, wherein the first processor is associated with a multi-level cache, the multi-level cache comprising the last level cache and one or more additional caches including at least a first level cache, wherein the first level cache is the first cache from which data is requested by the first processor and wherein the last level cache is the last cache from which data is requested by the first processor.

12. The apparatus of claim 7, wherein two or more processors of the multiprocessor system share a cache.

13. A system to improve cache coherency processing in multi-processor systems, the system comprising:
a multiprocessor digital processing device comprising two or more processors and at least one cache associated with the two or more processors, each processor comprising one or more processor cores;
a cache miss module that determines that a first processor in the multiprocessor digital processing device receives a cache miss, the cache miss occurring in response to a request for data from a cache associated with the first processor;
a determination module that determines one or more of whether an application associated with the cache miss is running on a single processor core and whether an application that is running on two or more processor cores is running on two or more processor cores that do not share a cache; and
a cache coherency module that executes a cache coherency algorithm in response to the determination module determining that the application associated with the cache miss is running on two or more processor cores that do not share a cache, the cache coherency algorithm checking for consistency between two or more unshared caches, wherein the cache coherency module skips execution of the cache coherency algorithm in response to the determination module determining that the application associated with the cache miss is running on one of a single processor core and two or more processor cores that share a cache.

14. The system of claim 13, wherein the digital processing device is one of a personal computer, laptop, server, personal digital assistant, and cell phone.

15. The system of claim 13, further comprising a memory wherein the determination module identifies a memory region within the memory assigned to an application that is running on one of a single processor core and two or more processor cores that share a cache, the determination module flagging the identified memory region.

16. The apparatus of claim 15, wherein the determination module determines that the application associated with the cache miss is running on one of a single processor core and two or more processor cores that share a cache by determining that the memory region assigned to the application is flagged.

17. The system of claim 16, further comprising a translation lookaside buffer associated with the first processor, the translation lookaside buffer configured to track memory addresses associated with the memory, wherein the memory region associated with the application is flagged by flagging addresses in the lookaside buffer associated with the identified memory region as being assigned to an application that is running on one of a single processor core and two or more processor cores that share a cache.

18. A computer program product comprising a computer readable storage medium having computer usable program code executable to perform operations for improving cache coherency processing in multi-processor systems, the operations of the computer program product comprising:
determining that a first processor in a multiprocessor system receives a cache miss, the cache miss occurring in response to a request for data from a cache associated with the first processor, the multiprocessor system comprising two or more processors, each processor in the multiprocessor system comprising one or more processor cores;
determining one or more of whether an application associated with the cache miss is running on a single processor core and whether an application that is running on two or more processor cores is running on two or more processor cores that do not share a cache;
executing a cache coherency algorithm in response to determining that the application associated with the cache miss is running on two or more processor cores that do not share a cache, the cache coherency algorithm checking for consistency between two or more unshared caches; and
skipping execution of the cache coherency algorithm in response to determining that the application associated with the cache miss is running on one of a single processor core and two or more processor cores that share a cache.

19. The computer program product of claim 18, further comprising identifying a memory region assigned to an application that is running on one of a single processor core and two or more processor cores that share a cache and flagging the memory region assigned to the application, wherein determining one or more of whether the application associated with the cache miss is running on one of a single processor core and two or more processor cores that share a cache comprises determining that the memory region assigned to the application is flagged.

20. An apparatus to improve cache coherency processing in multi-processor systems, the apparatus comprising:
a cache miss module that determines that a first processor in a multiprocessor system receives a cache miss, the cache miss occurring in response to a request for data from a last level cache associated with the first processor, the multiprocessor system comprising two or more processors, each processor in the multiprocessor system comprising one or more processor cores;
a determination module that identifies a memory region assigned to an application that is running on one of a single processor core and two or more processor cores that have a shared last level cache and flags the memory region assigned to the application, wherein the memory region associated with the application is flagged in a translation lookaside buffer associated with the first processor in response to the application being loaded in random access memory (“RAM”);
wherein the determination module determines one or more of whether an application associated with the cache miss is running on a single processor core and whether an application that is running on two or more processor cores is running on two or more processor cores that do not share a cache by determining whether the memory region associated with the application is flagged in the translation lookaside buffer; and
a cache coherency module that executes a cache coherency algorithm in response to the determination module determining that the application associated with the cache miss is running on two or more processor cores that do not share a cache, the cache coherency algorithm checking for consistency between two or more unshared caches, wherein the cache coherency module skips execution of the cache coherency algorithm in response to the determination module determining that the application associated with the cache miss is running on one of a single processor core and two or more processor cores that share a cache.
